(19) United States
(12) Patent Application Publication
(10) Pub. No.: US 2017/0249572 A1
(43) Pub. Date: Aug. 31, 2017

(54) Equipped-Human Reference Architecture

(71) Applicant: The Charles Stark Draper Laboratory, Inc., Cambridge, MA (US)

(72) Inventors: Jeffrey Joseph Cipolloni, Lexington, MA (US); Richard Hildebrant, Jamaica Plain, MA (US)

(21) Appl. No.: 15/443,843

(22) Filed: Feb. 27, 2017

Related U.S. Application Data
(60) Provisional application No. 62/300,246, filed on Feb. 26, 2016.

(51) Int. Cl. G06Q 10/06; G06F 19/28; G06F 19/18

(52) U.S. Cl. CPC G06Q 10/06311; G06F 19/18; G06F 19/28

(57) ABSTRACT

In an embodiment, a method includes loading, from a first database, a representation of an Equipped-Human Reference Architecture (EHRA) model that is based on a human-equipment-task framework. The method further includes, based on indications of polymorphic attributes of at least one of a human, a task, an equipment, and an operational environment as defined by the EHRA model, selected by a user, loading a plurality of properties associated with the received indications from a second database. The method further includes polymorphically adding the plurality of properties to the representation of the EHRA model. The method further includes providing an equipped human system (EHS) solution architecture based on the EHRA model with the plurality of properties by analyzing one or more needs of the human, the task, the equipment, and the operational environment and determining an EHS solution meeting each need. The method further includes updating the EHRA model based on EHS solution architecture.

### RELATED APPLICATION

This application claims the benefit of U.S. Provisional Application No. 62/300,246, filed on Feb. 28, 2016. The entire teachings of the above application are incorporated herein by reference.

### BACKGROUND

The successful application/design of most modern complex systems depends on human components as part of their system architectures. While the complexity of these systems may be complicated due to the human elements, most of these complex human centered system designs may still be well-engineered using traditional systems engineering approaches and methodologies. Reference architectures (RA) can define systems that are human centered, such as systems where the human is the core emphasis of the design.

### SUMMARY

In an embodiment, a method includes loading, from a first database, a representation of an Equipped-Human Reference Architecture (EHRA) model. The method further includes, based on indications of polymorphic attributes of at least one of a human, a task, an equipment, and an operational environment as defined by the EHRA model received from a user, loading properties associated with the received indications from a second database. The method further includes polymorphically adding the properties to the representation of the EHRA model. The method further includes providing an equipped human system (EHS) solution architecture based on the EHRA model with the plurality of properties by analyzing needs of the human, the task, the equipment, and the operational environment, and determining an EHS solution meeting each need. The method further includes updating the EHRA model based on EHS solution architecture.

In another embodiment, the method can further include polymorphically adding multiple indications of a human, a task, equipment, or operational environment.

In another embodiment, the EHRA model includes an environment model, an operational model, a task model, and an equipped human model. The method can further include exchanging messages between the environmental model, operational model, task model, and equipped human model. The method can further include, based on the exchanged messages, providing the EHS solution architecture.

In another embodiment, the representation of the EHRA model is in Unified Modeling Language. In another embodiment, providing the EHS solution architecture further provides multiple EHS solution architectures. The method can further include presenting, to the user, a cost metric, a compatibility metric, a weight metric, or a durability metric. In another embodiment, the method can further include enabling the user to select one of the EHS solutions, and placing an order, over a network, to purchase elements of the selected EHS solution, develop a new training based on the selected EHS solution, or develop a new commercial product based on the selected EHS solution.

In another embodiment, polymorphically adding the properties to the representation of the EHRA model further includes identifying a first of the properties and the second of the properties being polymorphically compatible, and combining the properties.

In an embodiment, a system includes a processor and a memory with computer code instructions stored therein. The memory is operatively coupled to said processor such that the computer code instructions configure the processor to implement an initialization module configured to load, from a first database, a representation of an Equipped-Human Reference Architecture (EHRA) model, an extraction module configured to, based on indications of a polymorphic attributes of at least one of a human, a task, an equipment, and an operational environment as defined by the EHRA model, received from a user, load a properties associated with the received indications from a second database, a combination module configured to polymorphically add the properties to the representation of the EHRA model, and a solution module configured to provide an equipped human system (EHS) solution architecture based on the EHRA model with the properties by analyzing needs of the human, the task, and the equipment and determining an EHS solution meeting each need, and further configured to update the EHRA model based on EHS solution architecture.

In an embodiment, a non-transitory computer-readable medium is configured to store instructions for implementing an Equipped-Human Reference Architecture (EHRA) model. The instructions, when loaded and executed by a processor, cause the processor to load, from a first database, a representation of an Equipped-Human Reference Architecture (EHRA) model, based on indications of polymorphic attributes of at least one of a human, a task, an equipment, and an operational environment defined by the EHRA model, received from a user, load a properties associated with the received indications from a second database, polymorphically add the plurality of properties to the representation of the EHRA model, provide an equipped human system (EHS) solution architecture based on the EHRA model with the properties by analyzing needs of the human, the task, and the equipment and determining an EHS solution meeting each need, and update the EHRA model based on EHS solution architecture.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram illustrating the five elements of the equipped-human design space, and constitute a Human-Equipment-Task (H-E-T) framework that defines the design space for EHS.

FIG. 2 is a diagram illustrating an example embodiment of a reference architecture employed to build and test systems that validates the equipped-human reference architecture approach.

FIG. 3A is a diagram illustrating the EHRA Super Vee Complex System Lifecycle Model 312 to develop an EHS solution architecture.

FIG. 3B is a diagram illustrating an example embodiment of the EHRA Super Vee Complex System Lifecycle Model to develop an EHS solution architecture.

FIG. 4 is a diagram illustrating of an initial EHRA Human as a System (HaaS) model that was developed to describe EHRA.

FIG. 5 is an diagram illustrating an example embodiment of an EHRA model having additional inputs to provide an output of an policeman EHS solution architecture.

FIG. 6A is a block diagram illustrating an example embodiment of the present disclosure.

FIG. 6B is a block diagram illustrating an example embodiment of the present disclosure.

FIG. 7 is a flow diagram illustrating an example embodiment of a process employed by the present invention.

FIG. 8 is a block diagram illustrating an example embodiment of a system employed by the present invention.

FIG. 9 illustrates a computer network or similar digital processing environment in which embodiments of the present invention may be implemented.

FIG. 10 is a diagram of an example internal structure of a computer (e.g., client processor/device or server computers) in the computer system of FIG. 9.

### DETAILED DESCRIPTION

A description of example embodiments of the invention follows.

In an embodiment, an Equipped-Human Reference Architecture (EHRA) is provided as a systems engineering tool for addressing the complexity inherent in developing human-centered systems. In an embodiment, the EHRA is set of architecture guidelines and constraints that define the complete equipped-human design space in a reusable and evolvable manner. Additionally, the EHRA should be extensible to provide usable systems engineering design tools to aid equipped-human systems (EHS) developers when they are designing and evolving specific EHS solution architectures.

Human-centered systems are, by their nature, complex. However, human-centered systems present designers with engineering challenges that are extremely complex and not well understood. Traditional systems engineering architecting approaches are not robust enough to aid human-centered systems engineers in managing the added inherent complexity of designing and implementing human-base architectures. In an embodiment of the present invention, an Equipped-Human Reference Architecture (EHRA) is a systems engineering approach for managing complexity in human-based system architectures and solutions across the equipped-human design space.

Reference Architectures (RAs) can be described as a high level design for a class of shared solutions, exhibiting their key concepts, relationships, and features. It is a starting point for later stages of design and becomes customized and more detailed for specific applications. A reference design saves effort because each application does not have to repeat the early stages of development. At the architecture level or a reference design provides common language and understanding for parties with an interest in a project, identify technology risks and readiness level (TRL), and make early estimates of cost and schedule. The reference design, which is the result of applying the RA, includes system level goals, design principles, an architecture description, high level interactions between elements and the system environment, general element requirements, and element descriptions. Supporting data for reference architecture illustrates the reasoning for how the reference design architecture was made. The supporting data includes data sources, analyses to support concept selection, and tracking from goals to lower elements. Reference architectures are updated as the system concepts and specific applications become more detailed.

RAs share several key common characteristics. The highest-level objective for any RA is defining an architecture that describes and bounds the design space of possible solutions architectures. In EHRA, that design space is defined as any EHS. Additionally, the RA captures core elements that are common to any possible solution architecture contained within a design space. RA captures the key operational and environmental context in which the specific derived solution architectures are intended for use.

RA further is modular and, thus, reusable for designing, or redesigning, disparate solution architectures within a given design space. The RA is also capable of evolving by capturing lessons learned from predecessor system solutions and being capable of representing that captured knowledge as usable guidelines and constraints for use by future solution architecture designers.

Finally, the RA provides useful design tools that aid system designers in developing new solution architectures and/or in extending existing solution architectures within the design space of the RA.

Equipped-Human Reference Architecture (EHRA) is defined as a representation of common objects, design guidelines, and constraints, which represent the equipped-human design space from which specific Equipped Human Solution (EHS) architectures are derived. Equipped-Human System (EHS) Solution Architecture represent a specific instance of EHS system design that is engineered following the principles of the traditional systems engineering Vee lifecycle model.

The EHS solution architecture describes a system to equip a human perform particular task(s) in a particular operational environment, or a system to equip a group of humans to perform particular task(s) in a particular operational environment.

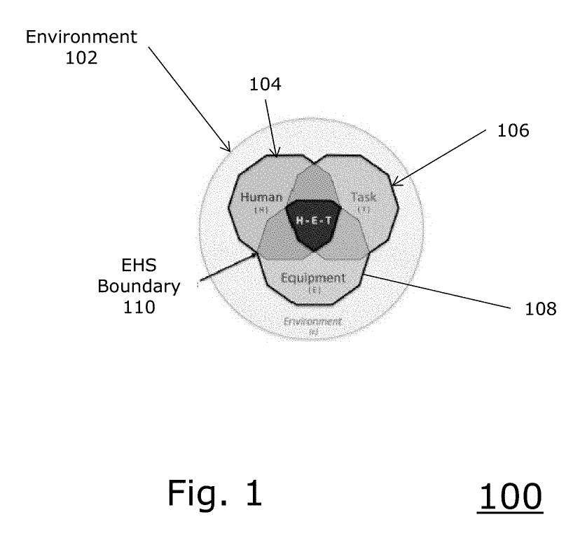

FIG. 1 is a diagram 100 illustrating the five elements of the equipped-human design space, and constitute a Human-Equipment-Task (H-E-T) framework that defines the design space for EHS. The H-E-T framework is also applicable to groups of similarly equipped-human systems such as a firefighting company or a soldier squad who have been trained to perform combined missions.

The five central elements of the Equipped-Human (EH) design space are (1) the human 104, (2) his/her equipment 108, (3) the task 106 they are being equipped to perform, (4) the environment 102 (e.g., operational environment) in which the task is executed, and (5) the EHS objective (not shown). To consider the EHS and design of the first three elements separately, the equipment 108 depends on the task 106 to be performed, and the environment 102. The task 106 that can be performed depends on the human's 104 abilities. Each of these elements is interrelated and comprises an integrated EHS. The environment 102 itself can be observed, but not designed or changed in any sense; however, a choice can sometimes be made about the environment 102 in which to conduct a given task. Therefore, the EHS boundary 110 represents the conceptual border between the characteristics of the human 104, task 106, and equipment 108, which the designer has more control over, and the environment 102, which often changes. However, while environments 102 are sometimes unpredictable, the designer can select an ideal environment for the task 106 as a baseline. The interrelationships between these elements define the measures of performance (MOPs), measures of effectiveness (MOEs) and technical performance measures (TPMs), such as soldier load (weight) or cognitive load, of any EHS.

Different human 104 class types can be distinguished by their capabilities, training, and experience, or behavior. For the development of the embodiments of the EHRA described herein, capabilities can be referred to as knowledge, training can be referred to as skills, and experience can be referred to as abilities. As further example, the human 104 class type can include restrictions of the human, such as medical, allergy, or religious restrictions. For example, a human 104 allergic to latex would not be able to use equipment 108 made of latex. As another example, a human 104 having a religious or conscientious objection to using animal products may need a vegetarian or vegan based equipment 108.

The equipment 108 of the EHS includes equipment worn by the equipped-human, transport equipment, communications equipment, or other equipment necessary to complete the specified tasks 106. Equipment 108 types are defined by the characteristics of function, properties, and capabilities.

The mission specifies tasks 106 that the EHS is intended to address.

The physical environment 102 includes terrain, temperature, moisture level, time of day, water sources, and other conditions define the range of environments that a given EHS must operate in to carry out their task. The physical environment can be characterized as urban, remote, sea, air, land, space, etc., each of which are associated with properties having expected condition ranges. Additionally there are operational environment considerations that are human centered. These operational variables include social behavior aspects of the human entity to be aligned with the task objectives. The analysis of different equipment can change based on the mission. For example, on most missions, equipment weight (e.g., soldier load) is a limiting factor. However, in higher altitude missions, gravity is less powerful, and therefore a human may be able to carry more weight. However, in higher altitude missions, air may also be thinner, which can affect the human's endurance. In a more extreme example, a mission taking place in space can disregard weight entirely, because it is a zero-gravity environment. However, that mission has to take into account other factors, such as equipment to supply air to the human, etc. The EHRA model can develop practical EHS solutions by considering all of these factors simultaneously.

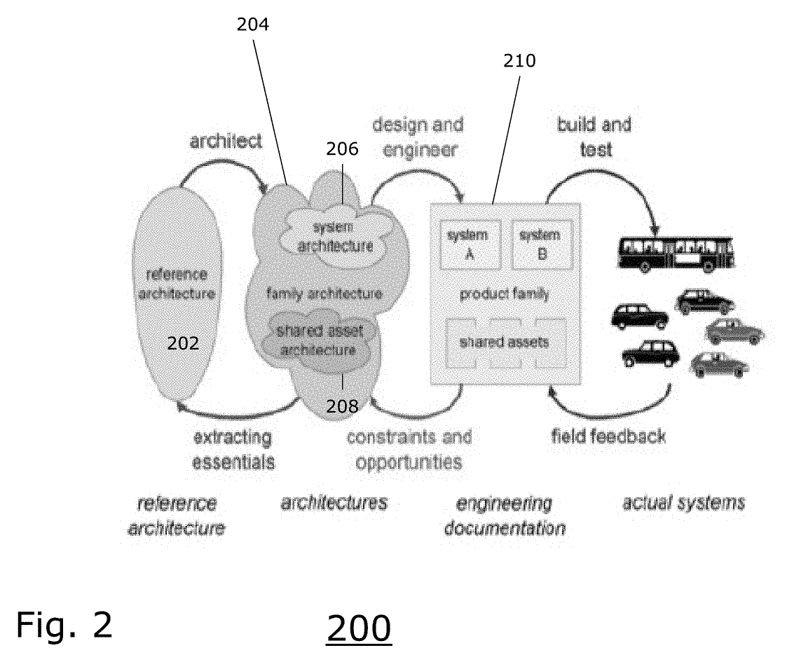

FIG. 2 is a diagram 200 illustrating an example embodiment of a reference architecture employed to build and test systems that validates the equipped human reference architecture approach. FIG. 2 illustrates the designing of a reference architecture as an iterative process. The reference architecture 202 is used to develop a family architecture, including a system architecture and a shared asset architecture 208. Using the family architecture, systems 210 can be designed and engineered. The built systems then inform field feedback for the systems 210 in engineering documentation. From the feedback, constraints and further development can be engineered into the family architecture 204. From there, essentials can be extracted to update the reference architecture 202.

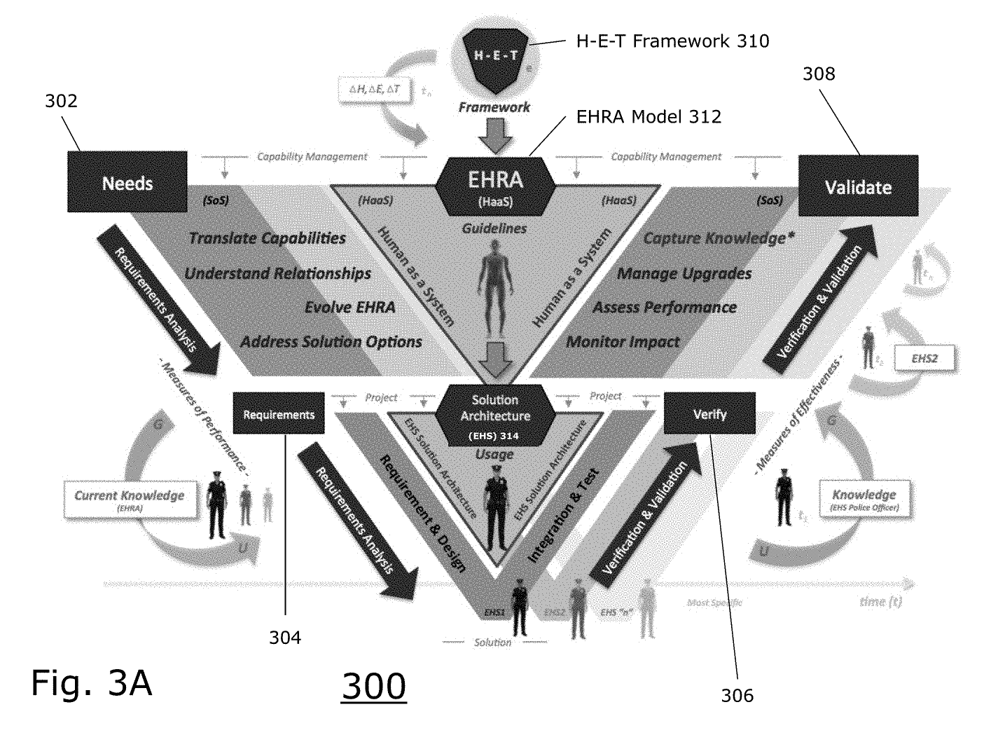

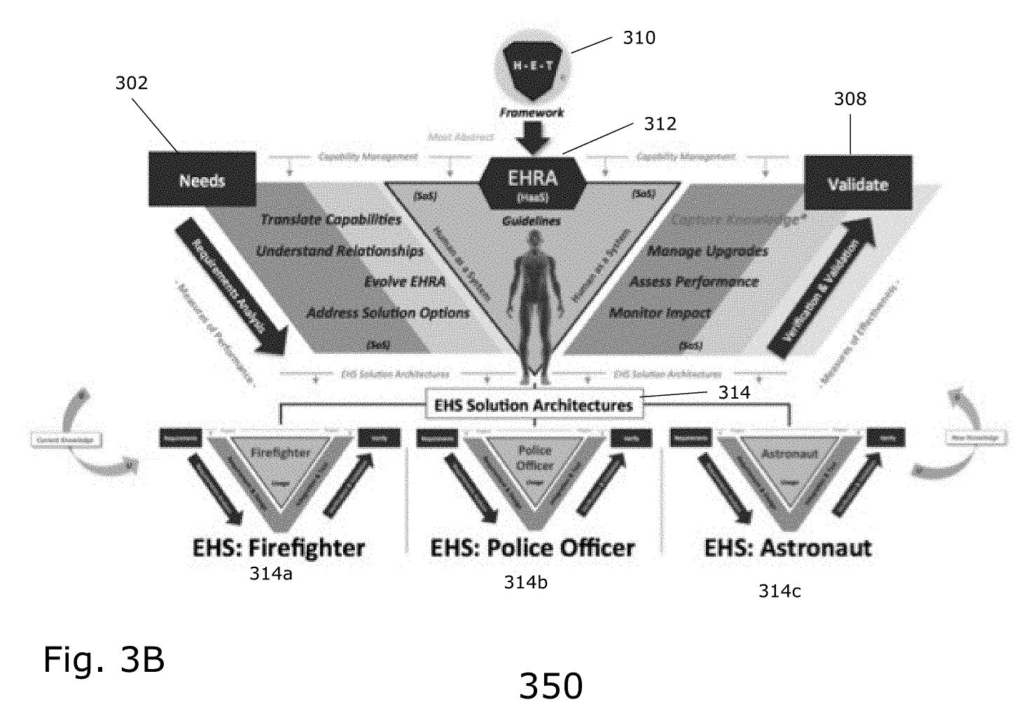

FIG. 3A is a diagram 300 illustrating the EHRA Super Vee Complex System Lifecycle Model 312 to develop an EHS solution architecture 314. FIG. 3A illustrates how EHRA 312 provides systems engineering guidance for adapting the concepts contained within the Human-Equipment-Task (H-E-T) framework 310 into a Human as a System (HaaS) architecture that provides guidelines, which systems engineers may use, or reuse, to build actual EHS solution architectures 314.

At the highest-level of the EHRA Super Vee Model 312, the H-E-T framework 310 defines the fundamental blueprint, or strategy, encompassed in all resulting EHS solution architectures 314. The second-level of the EHRA 312 Super Vee model describes the Systems of Systems (SoS) architectural guidelines and constraints, or EHRA 312, that are defined in terms of the HaaS architectural construct, or human as an equipment chassis. The third-level of the EHRA 312 Super Vee model describes how EHS system developers use the EHRA 312 HaaS architecture to design specific EHS solution architectures 314. The EHS solution architecture 314 is the specification and design that allows the systems engineer to build, or extend, specific EHS solution architectures 314 that are derived through the application of the higher-level EHRA 312 HaaS guidelines.

The EHRA model 312 shares common patterns and themes contained within the EHRA Super Vee Model. Unlike previous models, the EHRA Super Vee Model provides a specific road map for developing EHRA 312 in a refined and recognized Systems of Systems (SoS), or Human as a System (HaaS), approach. The EHRA model provides a representation of how the relationship complexity apparent in the abstract elements of the H-E-T Framework can be managed using the EHRA 312 HaaS architecture and how that EHRA 312 HaaS architecture may be used, and reused, to inform EHS system developers when developing specific instances, or extensions, of EHS solution architectures 314.

For systems engineers to use any RA, the RA must not only be instantiable, but the RA must also be extensible. Therefore, system developers can add, or extend, specific solutions architecture elements to the RA, which in turn, aids other systems engineers in defining and building actual EHS solution architectures based on the guidelines provided by the RA.

The EHRA model is based on needs 302 and requirements 304. From an analysis of the inputted needs, a solution architecture 314 can be developed. In an embodiment of the present disclosure, automated processes can translate capabilities to equipment and training, understand relationships of humans, equipment, training, and environment, and apply those relationships to the developed EHS Solution Architecture 314, and provide a solution. For example, a solution architecture 314 of a policeman may require a carrying of equipment such as a baton or driving of certain vehicles, such as a patrol car, or for SWAT missions, on armored personnel carrier. The EHRA model 312 should be able to automatically understand the relationships of the equipment the policeman carries to the clothes the policeman wears, and provide for storage for that equipment. That solution architecture 314 can then be verified 306 and validated 308, through virtual tests and in-person tests. Such verification 306 and validation 308 can provide information to further inform needs 302 and requirements 304 to further develop the EHS solution architecture 314 and in addition, the EHRA model 312.

FIG. 3B is a diagram 350 illustrating an example embodiment of the EHRA Super Vee Complex System Lifecycle Model 312 to develop an EHS solution architecture 314. While similar to the diagram 300 of FIG. 3A, the diagram 350 of FIG. 3B illustrates outputs of multiple EHS solution architectures 314. Examples of multiple outputs are an EHS: Firefighter 314a, EHS: Police Officer 314b, and EHS: Astronaut 314c. By developing one EHS solution output, the EHRA model 312 is then updated with information about the EHS solution, which enables the easier reproduction of the multiple EHS Solutions 314a-c. Based on the needs 302 and requirements, the developed EHS solution architectures 314 can vary. However, the EHRA model 312 can be applied to a wide range of needs for HaaS solutions.

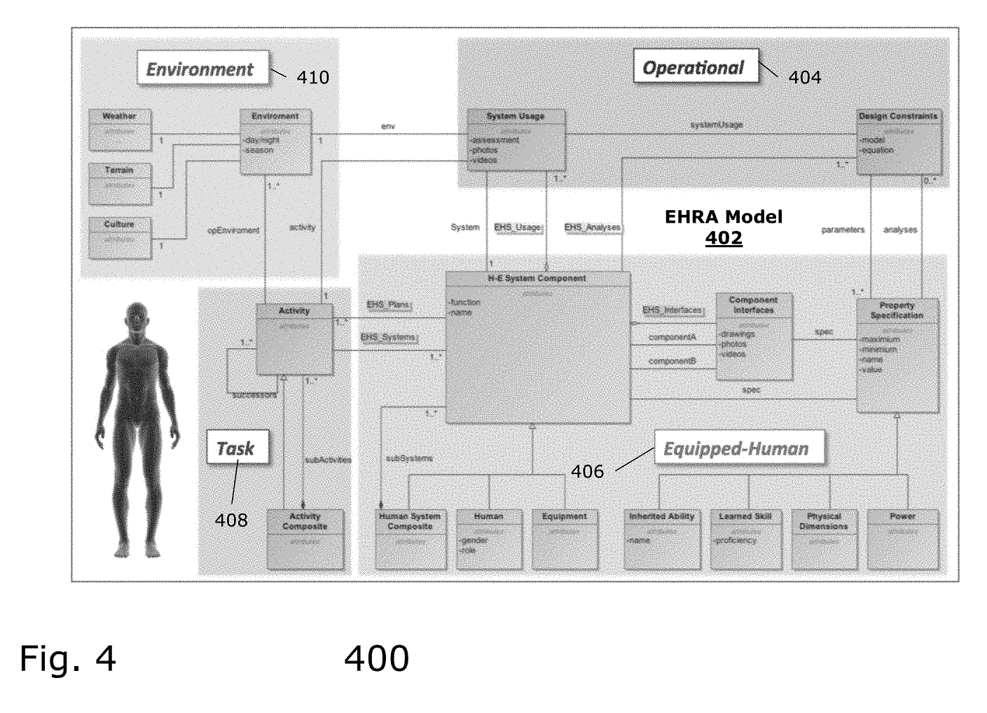

FIG. 4 is a diagram illustrating of an initial EHRA HaaS model 402 that was developed to describe EHRA. In an embodiment, the EHRA HaaS model 402 is represented in UML. The EHRA UML HaaS Model 402 captures the core system components and guidelines necessary to define the baseline equipped-human described in the H-E-T framework. Extending the EHRA HaaS UML Model 402 by employing subclasses allows EHS developers to instantiate specific EHS solution architectures throughout the EHS design space. In general, the EHRA UML Model 402 depicts an architecture that is simple and balanced.

Methods for representing RA can include sophisticated relational databases, detailed process diagrams and even simple drawings. In an embodiment, a Unified Modeling Language (UML) can be employed when developing reference architectures. The EHRA UML HaaS Model, illustrated by FIG. 4, captures the core system components and guidelines that are necessary to define the baseline equipped-human described in the H-E-T framework.

Extending the EHRA HaaS UML Model though the use of subclasses allows EHS developers to instantiate specific EHS solution architectures throughout the EHS design space. For example, the architecture of the EHRA model includes separate virtual modules representing the operation 404, equipped-human 406, task 408, and environment. Each respective virtual module is designed modularly, such that each module can communicate with other modules.

In general, the EHRA HaaS UML Model depicts an architecture that is simple and balanced. The EHRA 402 architecture captures the concepts described in the H-E-T framework, and also is specific enough to be extended to actual EHS solution architectures through the addition of subclasses that may subsequently be instantiated for actual EHS solution architectures.

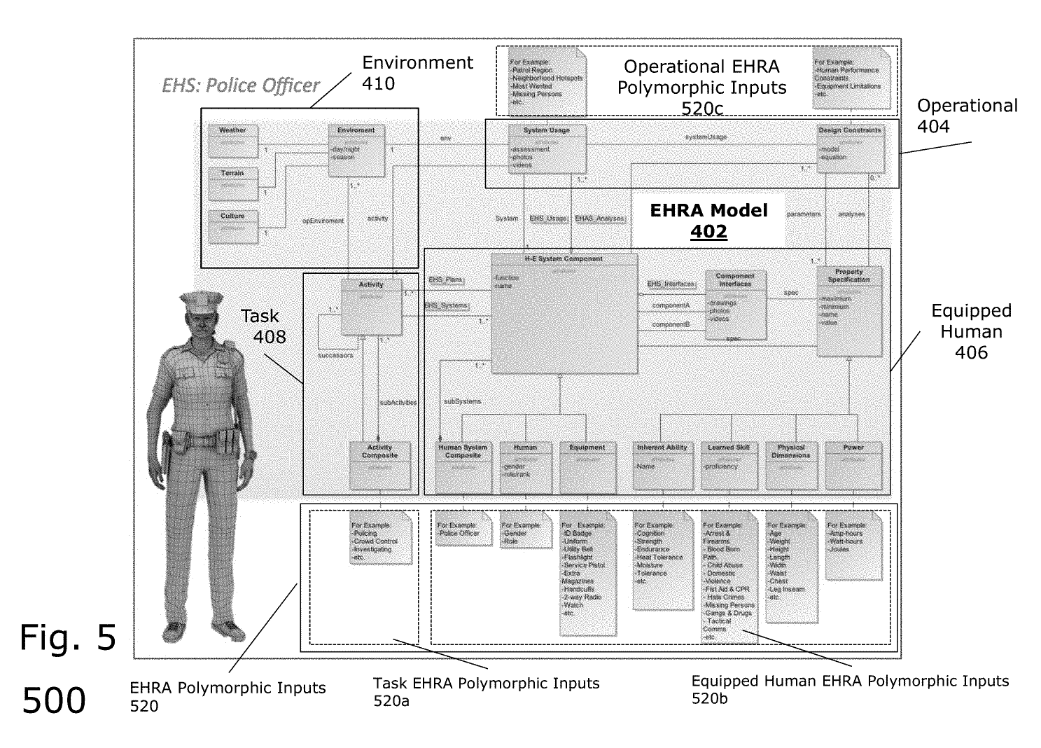

FIG. 5 is an diagram 500 illustrating an example embodiment of an EHRA model 502 having additional inputs to provide an output of an policeman EHS solution architecture. Police officers are individual humans who have been equipped and trained to respond to a multiple different tasks related to law enforcement and public safety, including, but not limited to, traffic enforcement, crime prevention, crime response, and first aid. An police officer EHS solution architecture can be defined from EHRA polymorhpic Inputs 520 for sub-classes of the EHRA model 402.

For example, Task EHRA polymorhpic inputs 520a can include activities such as Policing, Crowd Control, Investigating, etc.

As a further example, equipped human EHRA polymorhpic inputs 520b can include: (a) a human system composite of a job, such as a police officer; (b) information about the human, such as a gender, a role, or a rank, (c) suggested equipment, such as an ID Badge, Uniform, Utility Belt, Flashlight, Service Pistol, Extra Magazines, Handcuffs, Two-way Radio, Watch, etc.; (d) inherent abilities, such as cognition, strength, endurance, heat tolerance, moisture tolerance, etc.; (e) learned abilities, such as arrest & firearms, pathologies, child abuse, domestic violence, first aid & CPR, hate crimes, missing persons, gangs and drugs, and tactical communications; (f) physical dimensions, such as age, weight, height, length, width, waist, chest, leg inseam, etc., and (g) power, including amp-hours, watt-hours, and joules of electronics of the equipment.

As a further example, operational EHRA polymorhpic inputs 520c can include system usage inputs, such as patrol region, neighborhood hotspots, most wanted, missing persons, etc. The operational EHRA polymorhpic inputs 520c can further include design constraints, such as human performance constraints, and equipment limitations.

After receiving these inputs, the EHRA model 402 can reconcile all of the inputs to provide at least one recommended EHS solution architecture. For example, the equipped-human should be appropriate for the task at hand. The EHRA model 402 can thus determine, based on requirements of the EHRA polymorhpic inputs 520, contradictory inputs and reconcile the same. As one example, if the task is “investigating,” the human may need to be a detective rank or higher. This can overwrite lower ranks. As another example, a task of crowd control may require fewer lethal tools, such as firearms, and more crowd control tools, such as tasers and mace. The EHS solution can be updated accordingly.

In addition, the EHS solution can be appended, instead of corrected, based on certain inputs. For example, for a policeman who needs a firearm, a holster for the firearm is also needed, and can be inserted into the EHS solution architecture. The type of holster can be determined by properties of the task, such as the need to fit into small spaces, or the human, which can consider the type of materials the human is tolerant of.

For example, as a non-limiting example embodiment, the EHRA model 402 can compare all EHRA polymorhpic inputs 520 to each other to determine a best possible EHS solution architecture. As one example embodiment, a matrix can provide compatibility scores of each input requirement relative to other requirements. As an example, a score of 1.00 indicates complete compatibility, and a score of 0.00 indicates no compatibility, where values within that range can indicate possible compatibility. Each compatibility score can be loaded from a database. After determining the matrix, the EHRA model 402 can determine most compatible configurations by finding an optimal combination of all inputs.

A solution architecture that is similar to that of the police officer is a firefighter solution architecture.

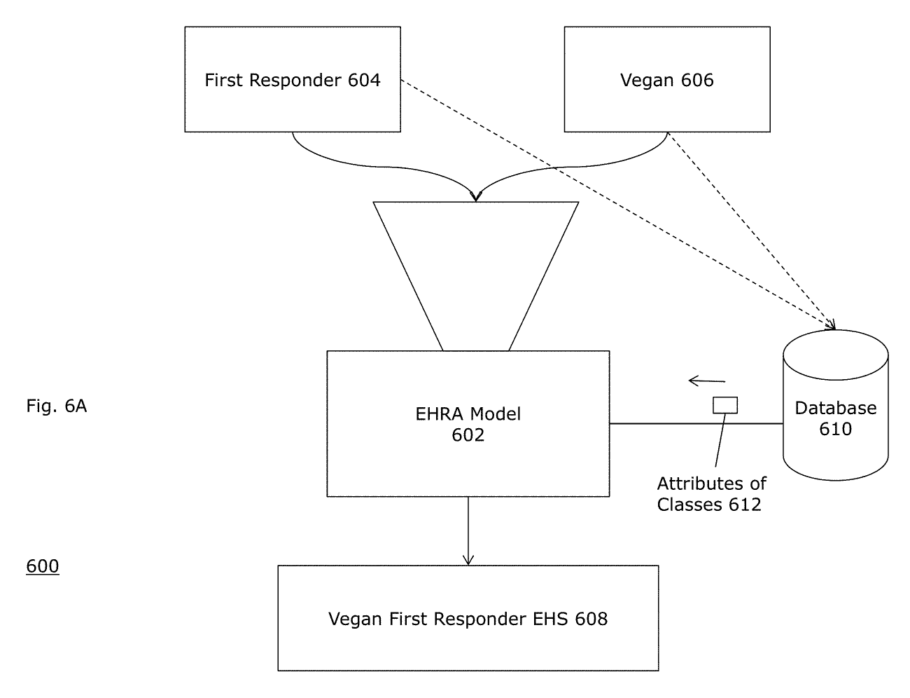

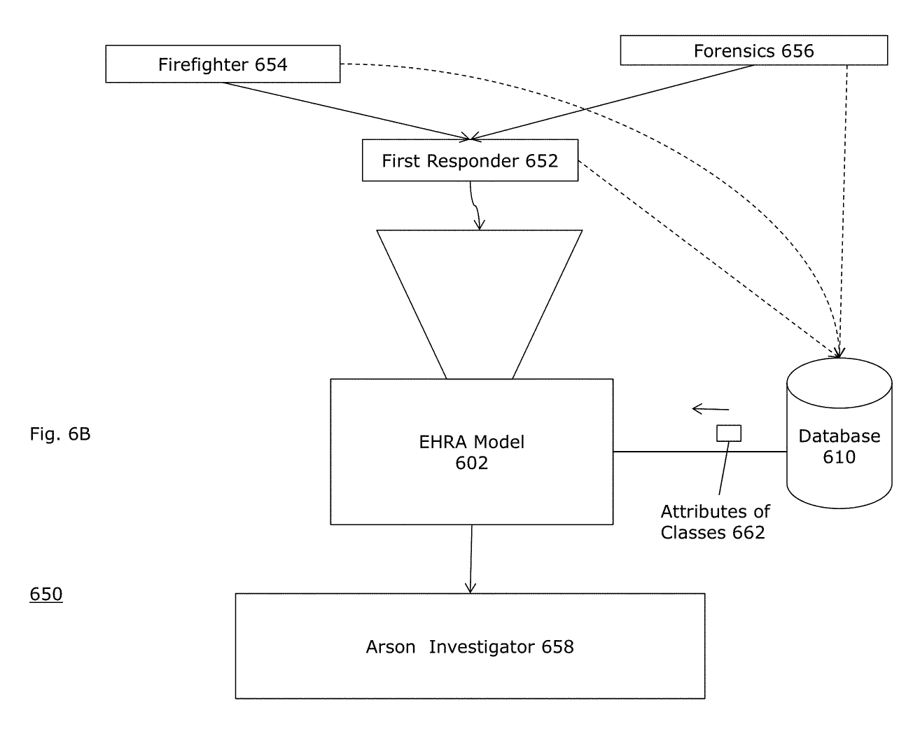

FIG. 6A is a block diagram 600 illustrating an example embodiment of the present disclosure. A processor receives inputs of a characteristic block of a first responder 604 and a characteristic block of a vegan 606. The processor provides these inputs to the EHRA model 602, which further retrieves attributes 612 of the first responder 604 and vegan 606 from a database 610. For example, attributes of a first responder 604 can include a uniform, identification, and generic first responder equipment, while attributes of a vegan can include a property indicating no animal products. Then, the processor and EHRA model 602 generate an EHS solution architecture of a vegan first responder 608. Such a solution architecture would provide a police officer with vegan equipment, and only allow tasks considered animal friendly, based on the attributes 612.

FIG. 6B is a block diagram 650 illustrating an example embodiment of the present disclosure. Each EHS is trained and similarly equipped to respond to emergency situations. Thus both EHS solution architectures share common solution architecture systems components such as uniforms, radios and CPR training. However, it is unlikely that the firefighter solution architecture should be equipped with a firearm or that the police officer solution architecture would ever be trained in operating a fire hydrant and hose. Because of the commonality at the higher level of the EHRA (e.g., emergency response training; hostile environment conditions; etc.), EHS developers can take advantage of these reusable aspects from other EHS when designing similar EHS solution architectures. Regardless of the specific EHS being developed, all EHS share the common system components defined in the EHRA HaaS UML Model, which should be reusable by all EHS developers when developing new EHS solution architectures. Therefore, a polymorphic structure can be developed that combines reusable aspects of different classes of equipped-humans to provide different EHS solution architectures.

In computer science, a polymorphic object is an object whose operations or values can be applied to operations or values of a different, but related, type. Polymorphism is described, in one example, in “Polymorphism (computer science),” from Wikipedia, which is hereby incorporated by reference in its entirety. A common example of polymorphism is the example of a Dinosaur data type, which may have value attributes such as Size and Weight, and operations such as Eating, Walking, and Breathing. All dinosaurs share these values and operations, but may use them in different ways. For example, a Brontosaurus Dinosaur performs Eating like all Dinosaur data types, but can only eat plants. Further, the Brontosaurus Dinosaur can execute Walking by moving its four legs. In contrast, a Tyrannosaurus Rex is a carnivorous dinosaur, so it eats meat. Therefore, the two Dinosaurs have the same Eating operation, but each executes it differently according to their data type. Similarly, a Tyrannosaurus Rex also walks, but does so on two legs. Therefore, while both Dinosaurs execute the same Walking function, they do so in different manners. Therefore, there are heterogeneous implementations of each Walking and Eating functions across different data types. However, the two Dinosaur data types likely execute Breathing in the same manner, so a Breathing function can be inherited from the parent Dinosaur data type. It is in this manner that properties can be combined. Similarly, Size and Weight values can be set to different values or bounded by different ranges based on the polymorphic data type. Therefore, the specific dinosaur types can overload functions (e.g., function overloading) over the parent functions.

In the context of polymorphism, ad hoc polymorphism can be when a function denotes different and potentially heterogeneous implementations depending on a limited range of individually specified types and combinations. Ad hoc polymorphism is supported in many languages using function overloading. Parametric polymorphism is when code is written without mention of any specific type and thus can be used transparently with any number of new types. In the object-oriented programming community, this is often known as generics or generic programming. In the functional programming community, this is often shortened to polymorphism. Subtyping (also called subtype polymorphism or inclusion polymorphism) can be when a name denotes instances of many different classes related by some common superclass. In the object-oriented programming community, this is often referred to as simply polymorphism. Therefore, “polymorphically adding,” as described herein, utilizes the concepts of polymorphism to combine the properties, loaded from the database, by relating similar functions and performing function overloading. However, a person of ordinary skill in the art can recognize that different manners of polymorphism can combine the properties loaded from the database, as described above. In such a manner, the polymorphic added properties improve the performance of the database in representing the multitude of interconnection with an EHRA and therefore, the computer system is needed to assist a designer of EHRA and EHS. The EHRA model provides the constructs that aid the EHS designers in building EHS solutions.

Therefore, the first responder 652 input can add in attributes from a firefighter 654 input and forensics 656 input in a polymorphic manner. A processor, in conjunction with the EHRA model 602, processes the polymorphically combined inputs (652, 654, and 656). The processor and the EHRA model 602 further retrieve attributes 612 of the first responder 652 input, firefighter 654 input, and forensics 656 from a database 610. For example, attributes of a first responder 652 can include a uniform, identification, and generic first responder equipment. Attributes of a firefighter 654 can include fireproof clothing and helmets, and firefighting equipment. Attributes of forensics training 656 can include a training level of detective. The system then outputs the EHS solution architecture of an arson investigator 658. For example, the system can combine the attributes of a firefighter 654 and forensics 656 training to ascertain that the resulting EHS solution architecture is an Arson Investigator 656, a HaaS having attributes of a first responder, firefighter, and a forensic investigator.

Ideally, EHRA provides many advantages for developers of EHS solution architectures. EHRA is intended to provide reusable guidelines and constraints that capture EHS patterns, and allows all developers of EHS to learn and profit from the experience of predecessor design efforts. The ability to reuse past EHS design information can aid system developers in scoping the cost and schedule for developing new EHS solution architectures by focusing systems engineering resources on the areas of the EHS design elements that are new and represent the greatest risk to engineering EHS. In other words, elements of EHS solution can be used to update the EHRA model, which informs future EHS solutions. The EHRA provides reusable, time-tested modules for developing EHS solution architectures which results in the EHS solution architectures should be of high quality and should be extremely dependable and maintainable until changes in human training; equipment technology and/or new missions require a replacement EHS solution architecture to be developed. Additionally, since EHRA should continue to provide current EHS design space engineering information to systems engineers, the resulting in EHS solution architectures that are developed should be well understood, robust and scalable.

Finally, the use of EHRA may present EHS systems developers with emergent systems engineering techniques that cannot be realized using more traditional methods.

While the H-E-T Framework provides a novel way to characterizing EHS, an effective EHRA system requires understanding about how humans react in a given environment and the scientific community's inability to quantitatively model these emergent human qualities. The EHRA HaaS UML model of embodiments of the present disclosure represent EHRA in a form that is extendable and useable by systems engineering practitioners for developing EHS solution architectures. The model encapsulates the H-E-T concepts into a reusable EHRA HaaS architecture from which actual EHS solution architectures can be derived through extension of the EHRA class structure. The EHRA UML model structure captures the system context in relation to operational considerations. The current EHRA UML model may be used to instantiate new EHS solution architectures as demonstrated in the EHS police officer solution architecture.

In summary, EHRA is an evolving systems engineering construct for EHS system developers to inform the design, development, deployment, assessment and sustainment of a solution specific complex system architectures that fall within design space of a EHS. EHRA captures the fundamental concepts of the complete EHS design space as expressed in the H-E-T framework. EHRA should also provide mechanisms to iteratively update and present those concepts, so that they can be used, and reused, by different EHS systems developers to build and deploy specific EHS solution architectures. The application of EHRA to the systems engineering methodology can be expressed using the EHRA Super Vee model. A practical EHRA HaaS UML model may be used by systems engineers to instantiate EHS solution architectures within the EHS design space.

The H-E-T framework defines the needs for all EHS. As a model, the EHRA represents EHS as HaaS architecture. As a practical systems engineering tool, the EHRA HaaS architecture provides system developers with a set of general, reusable and evolving systems engineering guidelines and constraints from which any EHS solution architecture may be realized. While there are many practical approaches that may be used to construct RA, the EHRA UML modeling approach is both usable, and reusable, by systems engineering practitioners and is extensible for EHRA developers and maintainers.

In conclusion, EHRA should provide EHS developers with a reusable, modular set of guidelines and constraints for engineering EHS solution architectures across the spectrum of the EHS design space. In order to provide those capabilities to EHS systems engineers, the EHRA construct encompasses the following characteristics:
EHRA should capture and represent aspects of EHS that are common and necessary to all EHS.
EHRA captures the operational and environmental context for a given EHS solution architecture.
EHRA is in a form usable and suitable for practitioners of systems engineering.
EHRA provides EHS developers with the necessary design aids for engineering EHS.
EHRA is extensible to predecessor EHS solution architectures and is instantiable for the development of new EHS solution architecture within the EHS design space.

EHRA should evolve with changes to the EHS design space as new EHS solution architectures are built to address new missions and/or to incorporate novel technologies so that future EHS developers can reuse the components and information gained through those systems engineering advances in future EHS implementations.

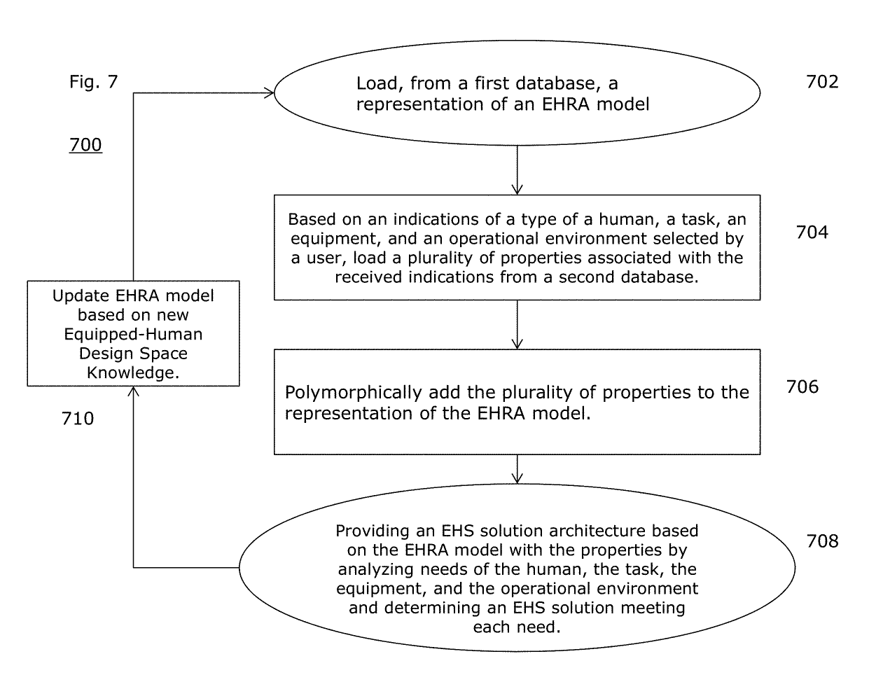

FIG. 7 is a flow diagram 700 illustrating an example embodiment of a process employed by the present disclosure. The process loads, from a first database, a representation of an Equipped-Human Reference Architecture (EHRA) model (702). Based on an indications of a type of a human, a task, an equipment, and an operational environment selected by a user, the process loads a plurality of properties associated with the received indications from a second database (704). The process polymorphically adds the plurality of properties to the representation of the EHRA model (706). The process then provides an equipped human system (EHS) solution architecture based on the EHRA model with the plurality of properties by analyzing one or more needs of the human, the task, the equipment, and the operational environment and determining an EHS solution meeting each need (708). Based on the developed EHS solution and the new equipped-human design space knowledge defined therein, the process then updates the EHRA model (710). In other words, applying the EHRA reference architecture outputs the EHS solution architecture, and in turn provides additional state information that evolves the EHRA model. As such, every use of the EHRA model to develop an EHS solution provides feedback to further update the EHRA model for future uses. One example of such a feedback look is the case of developing an EHS solution architecture for scuba equipment. Scuba equipment can be used to avoid fumes in certain environments, so a first instance of applying the scuba equipment might be to design a firefighter EHS solution. In doing so, the EHRA model learns the advantages of scuba equipment (e.g., the types of fumes and chemicals it protects its user from) and its disadvantages (e.g., weight, form factor, incompatibility with other eyewear). Then, if a user requests another use of the scuba equipment under different circumstances, for example, with a police officer, the data previously learned can be applied to the police officer. For example, if an attribute of the police office is vision impaired, the EHS solution would remember the information learned about the scuba being incompatible with other eyewear, and propose a solution of contact lenses, or prescription scuba lenses.

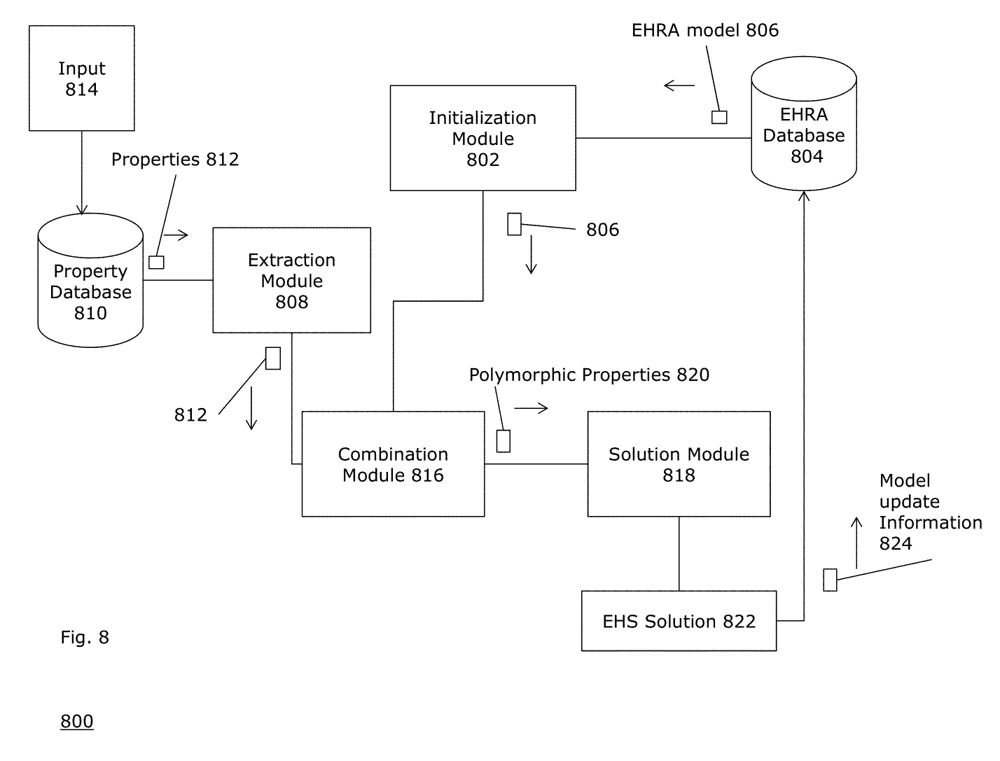

FIG. 8 is a block diagram 800 illustrating an example embodiment of a system employed by the present disclosure. An initialization module 802 loads an EHRA model 806 from an EHRA database 804. The initialization module 802 can load the EHRA model 806 based on user input indicating a type of EHRA model 806 to select, in some embodiments.

An extraction module 808 further loads properties 812 from a property database 810 based on input 814 describing polymorphic attributes of at least one of a human, a task, an equipment, and an operational environment as defined by the EHRA model. The extraction module forwards the properties 812 to a combination module 816, and the initialization module forwards the EHRA input 806 to the combination module 816. The combination module 816 generates polymorphic properties 820 by combining the properties 812 with the EHRA model 806. The polymorphic properties 820 are forwarded to the solution module 818, which generates an EHS solution 822. The system then extracts model update information 824 from the EHS solution 822 to send to the EHRA database 804. Model update information 824 can include, as described above, any information learned from the development of the EHS solution 822, such as incompatibilities or advantages of the described combination of properties 812.

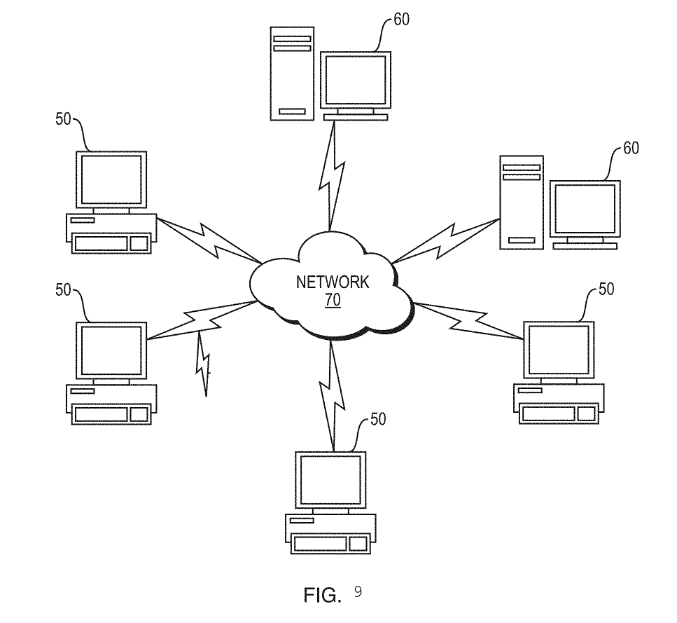

FIG. 9 illustrates a computer network or similar digital processing environment in which embodiments of the present disclosure may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

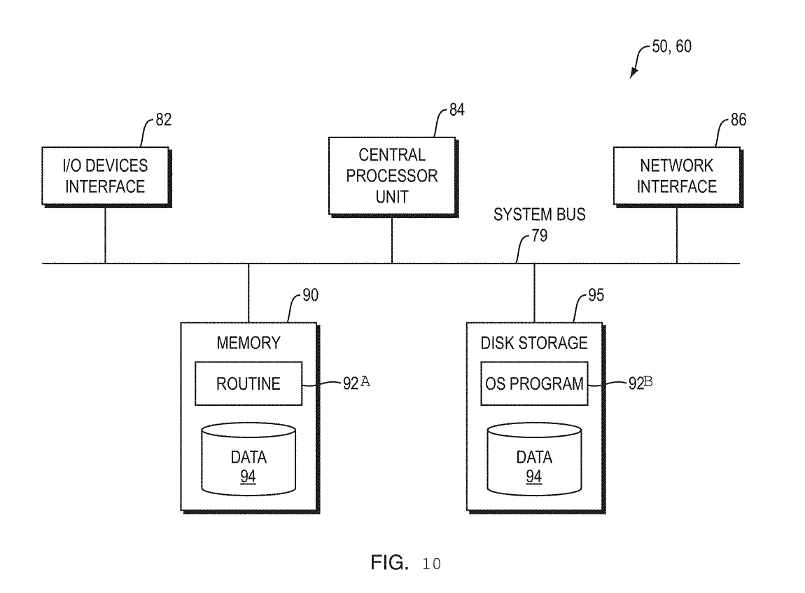

FIG. 10 is a diagram of an example internal structure of a computer (e.g., client processor/device 50 or server computers 60) in the computer system of FIG. 9. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 9). Memory 90 provides volatile storage for computer software instructions 92 and data 94 used to implement an embodiment of the present disclosure (e.g., initialization module, extraction module, combination module, and solution module code detailed above). Disk storage 95 provides non-volatile storage for computer software instructions 92 and data 94 used to implement an embodiment of the present disclosure. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the disclosure system. The computer program product 92 can be installed by any suitable software installation procedure, as is well known in the art. In another embodiment, at least a portion of the software instructions may also be downloaded over a cable communication and/or wireless connection. In other embodiments, the disclosure programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present disclosure routines/program 92.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method comprising:
loading, from a first database, a representation of an Equipped-Human Reference Architecture (EHRA) model;
based on indications of polymorphic attributes of at least one of a human, a task, an equipment, and an operational environment as defined by the EHRA model, selected by a user, loading a plurality of properties associated with the received indications from a second database;
polymorphically adding the plurality of properties to the representation of the EHRA model;
providing an equipped human system (EHS) solution architecture based on the EHRA model with the plurality of properties by analyzing one or more needs of the human, the task, the equipment, and the operational environment and determining an EHS solution meeting each need; and
updating the EHRA model based on EHS solution architecture.

2. The method of claim 1, further comprising:
polymorphically adding multiple indications of at least one of the human, the task, the equipment, and the operational environment.

3. The method of claim 1, wherein the EHRA model includes an environment model, an operational model, a task model, and an equipped human model, and further comprises:
exchanging messages between the environmental model, operational model, task model, and equipped human model; and
based on the exchanged messages, providing the EHS solution architecture.

4. The method of claim 1, wherein the representation of the EHRA model is in Unified Modeling Language.

5. The method of claim 1, wherein providing the EHS solution architecture further provides a plurality of EHS solution architectures, the method further comprising:
presenting, to the user, at least one of a cost metric, a compatibility metric, a weight metric, and a durability metric.

6. The method of claim 5, further comprising:
enabling the user to select one of the plurality of EHS solutions; and
at least one of: (a) placing an order, over a network, to purchase elements of the selected EHS solution, (b) developing a new training based on the selected EHS solution, and (c) developing a new commercial product based on the selected EHS solution.

7. The method of claim 1, wherein polymorphically adding the plurality of properties to the representation of the EHRA model further includes:
identifying a first of the properties and the second of the properties being polymorphically compatible; and
combining the properties.

8. A system comprising:
a processor; and
a memory with computer code instructions stored therein, the memory operatively coupled to said processor such that the computer code instructions configure the processor to implement:
an initialization module configured to load, from a first database, a representation of an Equipped-Human Reference Architecture (EHRA) model;
an extraction module configured to, based on indications of polymorphic attributes of at least one of a human, a task, an equipment, and an operational environment as defined by the EHRA model, selected by a user, load a plurality of properties associated with the received indications from a second database;
a combination module configured to polymorphically add the plurality of properties to the representation of the EHRA model; and
a solution module configured to provide an equipped human system (EHS) solution architecture based on the EHRA model with the plurality of properties by analyzing one or more needs of the human, the task, the equipment, and the operational environment and determining an EHS solution meeting each need, and update the EHRA model based on EHS solution architecture.

9. The system of claim 8, wherein the combination module is further configured to polymorphically add multiple indications of at least one of the human, the task, the equipment, and the operational environment.

10. The system of claim 8, wherein:
the initialization module is further configured to generate, within the EHRA model, an environment model, an operational model, a task model, and an equipped human model; and
the solution module is further configured to exchange messages between the environmental model, operational model, task model, and equipped human model, and based on the exchanged messages, providing the EHS solution architecture.

11. The system of claim 8, wherein the representation of the EHRA model is in Unified Modeling Language.

12. The system of claim 8, wherein the solution module is further configured to provide a plurality of EHS solution architectures, and present, to the user, at least one of a cost metric, a compatibility metric, a weight metric, and a durability metric.

13. The system of claim 12, wherein the solution module is further configured to enable the user to select one of the plurality of EHS solutions, and place an order, over a network, to purchase elements of the selected EHS solution.

14. The system of claim 8, wherein polymorphically adding the plurality of properties to the representation of the EHRA model further includes:
identifying a first of the properties and the second of the properties being polymorphically compatible; and
combining the properties.

15. A non-transitory computer-readable medium configured to store instructions for implementing an Equipped-Human Reference Architecture (EHRA) model, the instructions, when loaded and executed by a processor, causes the processor to:
load, from a first database, a representation of an Equipped-Human Reference Architecture (EHRA) model;
based on indications of polymorphic attributes of at least one of a human, a task, an equipment, and an operational environment as defined by the EHRA model, selected by a user, load a plurality of properties associated with the received indications from a second database;
polymorphically add the plurality of properties to the representation of the EHRA model;
provide an equipped human system (EHS) solution architecture based on the EHRA model with the plurality of properties by analyzing one or more needs of the human, the task; the equipment and the operational environment and determining an EHS solution meeting each need; and
updating the EHRA model based on EHS solution architecture.

16. The non-transitory computer-readable medium of claim 15, wherein the instructions further cause the processor to:
polymorphically add multiple indications of at least one of the human, the task, the equipment, and the operational environment.

17. The non-transitory computer-readable medium of claim 15, wherein the EHRA model includes an environment model, an operational model, a task model, and an equipped human model, and wherein the instructions further cause the processor to:
exchange messages between the environmental model, operational model, task model, and equipped human model; and
based on the exchanged messages, provide the EHS solution architecture.

18. The non-transitory computer-readable medium of claim 15, wherein the representation of the EHRA model is in Unified Modeling Language.

19. The non-transitory computer-readable medium of claim 15, wherein providing the EHS solution architecture further provides a plurality of EHS solution architectures, wherein the instructions further cause the processor to:
present, to the user, at least one of a cost metric, a compatibility metric, a weight metric, and a durability metric.

20. The non-transitory computer-readable medium of claim 19, wherein the instructions further cause the processor to:
enable the user to select one of the plurality of EHS solutions; and
place an order, over a network, to purchase elements of the selected EHS solution.
